(19) United States
(12) Patent Application Publication
(10) Pub. No.: US 2008/0042935 A1
(43) Pub. Date: Feb. 21, 2008

(54) Plasma display apparatus and method of driving the same

(75) Inventors: Muk Hee Kim, Daegu (KR); Yun Kwon Jung, Gumi-si (KR); Hyun Jae Lim, Narnyangjoo-si (KR); Yong Hyun Huh, Busan-si (KR)

Correspondence Address: KED & ASSOCIATES, LLP, P.O. Box 221200, Chantilly, VA, 20153-1200, US

(73) Assignee: LG Electronics Inc.

(21) Appl. No.: 11/638,591

(22) Filed: Dec. 14, 2006

(30) Foreign Application Priority Data
Aug. 16, 2006 (KR) 10-2006-0076957

(51) Int. Cl. G09G 3/28

(52) U.S. Cl. 345/68

(57) ABSTRACT

A plasma display apparatus and a method of driving the same are disclosed. The plasma display apparatus includes a plasma display panel including a first electrode and a second electrode, and a driver. The driver supplies a rising signal and a falling signal to the first electrode during a reset period, and supplies a positive polarity signal to the second electrode during the reset period. Further, the driver supplies a sustain bias signal to the second electrode after the passage of a predetermined duration of time from an end time point of the supplying of the positive polarity signal.

This Nonprovisional application claims priority under 35 U.S.C. § 119(a) on Patent Application No. 10-2006-0076957 filed in Korea on Aug. 16, 2006 the entire contents of which are hereby incorporated by reference.

### BACKGROUND

1. Field

This document relates to a plasma display apparatus and a method of driving the same.

2. Description of the Background Art

A plasma display apparatus includes a plasma display panel having a plurality of electrodes, and a driver supplying a predetermined driving signal to the electrodes of the plasma display panel.

The plasma display panel includes a phosphor layer positioned inside discharge cells partitioned by barrier ribs. The driver supplies the driving signal to the discharge cell through the electrodes.

The driving signal supplied to the discharge cell generates a discharge. When the driving signal generates the discharge inside the discharge cells, a discharge gas filled in the discharge cells generates vacuum ultraviolet rays, which thereby cause phosphors formed inside the discharge cells to emit light, thus displaying an image on the screen of the plasma display panel.

### SUMMARY

In one aspect, a plasma display apparatus comprises a plasma display panel including a first electrode and a second electrode, and a driver that supplies a rising signal and a falling signal to the first electrode during a reset period, supplies a positive polarity signal to the second electrode during the reset period, and supplies a sustain bias signal to the second electrode after the passage of a predetermined duration of time from an end time point of the supplying of the positive polarity signal.

Implementations may include one or more of the following features. For example, the sustain bias signal may be supplied to the second electrode during a set-down period of the reset period or near the beginning of an address period.

The positive polarity signal may be supplied to the second electrode during the supplying of the rising signal to the first electrode.

The positive polarity signal may be supplied to the second electrode prior to an end time point of the supplying of the rising signal.

A magnitude of a voltage of the positive polarity signal may be substantially equal to a magnitude of a voltage of a sustain signal supplied to the first electrode or the second electrode during a sustain period.

A magnitude of a voltage of the positive polarity signal may be more than a magnitude of a voltage of the sustain bias signal.

The width of the positive polarity signal may be smaller than the width of a sustain signal having the widest width in a plurality of sustain signals supplied to the first electrode or the second electrode during a sustain period.

The driver may supply the positive polarity signal to the second electrode during reset periods of one or more subfields of the remaining subfields except a first subfield in a plurality of subfields of a frame.

The predetermined duration of time ranging from the end time point of the supplying of the positive polarity signal to a start time point of the supplying of the sustain bias signal may be longer than the width of the positive polarity signal.

When the width of the positive polarity signal is set to a, and the predetermined duration of time ranging from the end time point of the supplying of the positive polarity signal to the start time point of the supplying of the sustain bias signal is set to b, a ratio (b/a) of “b” to “a” may be more than 1 and may be equal to or less than 10.

In another aspect, a method of driving a plasma display apparatus comprises supplying a rising signal and a falling signal to a first electrode during a reset period, supplying a positive polarity signal to a second electrode during the reset period, and supplying a sustain bias signal to the second electrode after the passage of a predetermined duration of time from an end time point of the supplying of the positive polarity signal to the second electrode.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

### BRIEF DESCRIPTION OF THE DRAWINGS

The accompany drawings, which are included to provide a further understanding of the invention and are incorporated in and constitute a part of this specification, illustrate embodiments of the invention and together with the description serve to explain the principles of the invention.

FIG. 1 illustrates the configuration of a plasma display apparatus according to one embodiment;

FIG. 2 illustrates the structure of a plasma display panel of the plasma display apparatus according to one embodiment;

FIG. 3 illustrates the structure of an electrode of the plasma display panel according to one embodiment;

FIG. 4 illustrates a method for representing a gray level of an image in the plasma display apparatus according to one embodiment;

FIG. 5 illustrates a driving waveform supplied during one subfield when driving the plasma display apparatus according to one embodiment;

FIGS. 6a and 6b illustrate modifications of a rising signal and a second falling signal of FIG. 5;

FIGS. 7a to 7c illustrate modifications of a supply time point of a positive polarity signal of FIG. 5;

FIG. 8 illustrates modifications of a shape pattern of a positive polarity signal of FIG. 5;

FIG. 9 illustrate a modification of a sustain signal of FIG. 5;

FIG. 10 illustrate another modification of a sustain signal of FIG. 5;

FIG. 11 illustrates a light characteristic depending on a sustain signal of FIG. 10; and

FIG. 12 illustrates another example of an operation of the plasma display apparatus according to one embodiment.

### DETAILED DESCRIPTION OF PREFERRED EMBODIMENTS

Preferred embodiments of the present invention will be described in a more detailed manner with reference to the drawings.

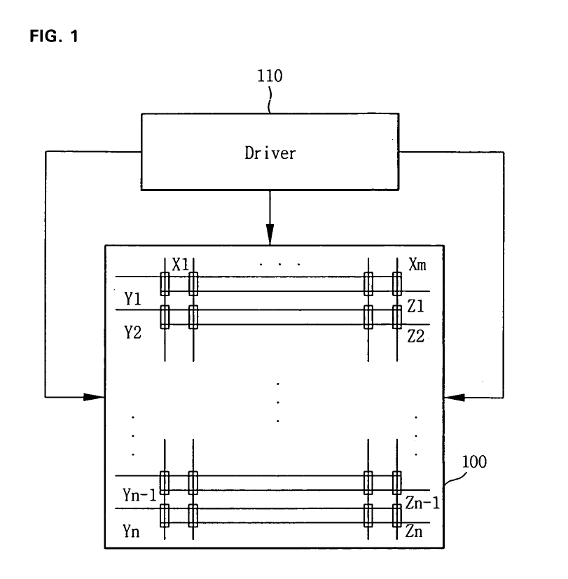

FIG. 1 illustrates the configuration of a plasma display apparatus according to one embodiment.

Referring to FIG. 1, the plasma display apparatus according to one embodiment includes a plasma display panel 100 and a driver 110.

The driver 110 supplies a rising signal and a falling signal to a first electrode of the plasma display panel, and a positive polarity signal to a second electrode of the plasma display panel 100 during a reset period. After the passage of a predetermined duration of time from the supplying of the positive polarity signal to the second electrode, the driver 110 supplies a Z-bias voltage to the second electrode.

The driver 110 may be formed in the form of one board, or the driver 110 may be formed in the form of a plurality of boards depending on the electrodes of the plasma display panel.

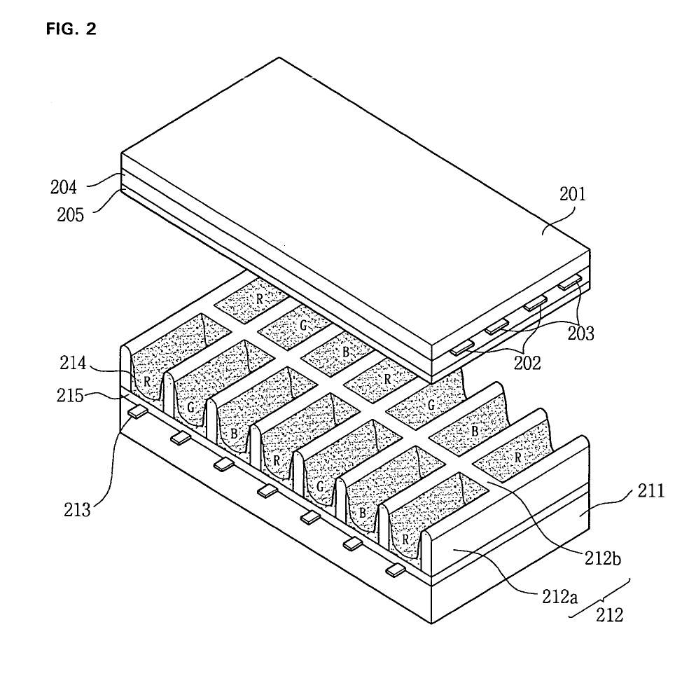

FIG. 2 illustrates the structure of a plasma display panel of the plasma display apparatus according to one embodiment. As illustrated in FIG. 2, the plasma display panel according to one embodiment includes a front substrate 201 and a rear substrate 211 which are coalesced with each other. On the front substrate 201, a first electrode 202 and a second electrode 203 are formed in parallel to each other. On the rear substrate 211, a third electrode 213 is formed to intersect the first electrode 202 and the second electrode 203.

The upper dielectric layer 204 for covering the first electrode 202 and the second electrode 203 is formed on an upper portion of the front substrate 201 on which the first electrode 202 and the second electrode 203 are formed.

The upper dielectric layer 204 limits discharge currents of the first electrode 202 and the second electrode 203, and provides insulation between the first electrode 202 and the second electrode 203.

A protective layer 205 is formed on an upper surface of the upper dielectric layer 204 to facilitate discharge conditions. The protective layer 205 may be formed by deposing a material such as magnesium oxide (MgO) on an upper portion of the upper dielectric layer 204.

A lower dielectric layer 215 for covering the third electrode 213 is formed on an upper portion of the rear substrate 211 on which the third electrode 213 is formed. The lower dielectric layer 215 provides insulation of the third electrode 213.

Barrier ribs 212 of a stripe type, a well type, a delta type, a honeycomb type, and the like, may be formed on an upper portion of the lower dielectric layer 215 to partition discharge spaces (i.e., discharge cells). A red (R) discharge cell, a green (G) discharge cell, and a blue (B) discharge cell, and the like, are formed between the front substrate 201 and the rear substrate 211.

In addition to the red (R), green (G), and blue (B) discharge cells, a white (W) discharge cell or a yellow (Y) discharge cell may be further formed between the front substrate 201 and the rear substrate 211.

Pitches of the red (R), green (G), and blue (B) discharge cells may be substantially equal to one another. However, to improve luminous efficiency of an image when displaying the image using the plasma display apparatus, the pitches of the red (R), green (G), and blue (B) discharge cells may be controlled.

In this case, the pitches of all of the red (R), green (G), and blue (B) discharge cells may be different from one another, or alternatively, the pitch of two discharge cells of the red (R), green (G), and blue (B) discharge cells may be different from the pitch of the remaining one discharge cell.

The plasma display panel according one embodiment may have various forms of barrier rib structures as well as a structure of the barrier rib 212 illustrated in FIG. 2. For instance, the barrier rib 212 includes a first barrier rib 212b and a second barrier rib 212a. The barrier rib 212 may have a differential type barrier rib structure in which the height of the first barrier rib 212b and the height of the second barrier rib 212a are different from each other, a channel type barrier rib structure in which a channel usable as an exhaust path is formed on at least one of the first barrier rib 212b or the second barrier rib 212a, a hollow type barrier rib structure in which a hollow is formed on at least one of the first barrier rib 212b or the second barrier rib 212a, and the like.

In the differential type barrier rib structure, the height of the first barrier rib 212b may be less than the height of the second barrier rib 212a. Further, in the channel type barrier rib structure or the hollow type barrier rib structure, a channel or a hollow may be formed on the first barrier rib 212b.

While the plasma display panel according to one embodiment has been illustrated and described to have the red (R), green (G), and blue (B) discharge cells arranged on the same line, it is possible to arrange them in a different pattern. For instance, a delta type arrangement in which the red (R), green (G), and blue (B) discharge cells are arranged in a triangle shape may be applicable. Further, the discharge cells may have a variety of polygonal shapes such as pentagonal and hexagonal shapes as well as a rectangular shape.

A predetermined discharge gas is filled in the discharge cells partitioned by the barrier ribs 212.

Phosphor layers 214 for emitting visible light for an image display when generating an address discharge are formed inside the discharge cells partitioned by the barrier ribs 212. For instance, red (R), green (G) and blue (B) phosphor layers may be formed inside the discharge cells.

A white (W) phosphor layer and/or a yellow (Y) phosphor layer may be further formed in addition to the red (R), green (G) and blue (B) phosphor layers.

The thicknesses (widths) of the phosphor layers 214 formed inside the red (R), green (G) and blue (B) discharge cells may be different from to one another. For instance, the thickness of the phosphor layer 214 formed inside at least one of the red (R), green (G) and blue (B) discharge cells may be different from the thicknesses of the phosphor layers 214 formed inside the other discharge cells.

It should be noted that only one example of the plasma display panel according to one embodiment has been illustrated and described above, and the embodiment is not limited to the plasma display panel of the above-described structure. For instance, although the above description illustrates a case where the upper dielectric layer 204 and the lower dielectric layer 215 each are formed in the form of a single layer, at least one of the upper dielectric layer 204 and the lower dielectric layer 215 may be formed in the form of a plurality of layers.

A black layer (not shown) for absorbing external light may be further formed on the upper portion of the barrier ribs 212 to prevent the reflection of the external light caused by the barrier ribs 212.

Further, a black layer (not shown may be further formed at a predetermined position on the front substrate 201 corresponding to the barrier ribs 212.

The third electrode 213 formed on the rear substrate 211 may have a substantially constant width or thickness. Further, the width or thickness of the third electrode 213 inside the discharge cell may be different from the width or thickness of the third electrode 213 outside the discharge cell. For instance, the width or thickness of the third electrode 213 inside the discharge cell may be more than the width or thickness of the third electrode 213 outside the discharge cell.

In this way, the structure of the plasma display panel of the plasma display apparatus according to one embodiment may be changed in various ways.

Although FIG. 2 has illustrated and described a case where the first electrode 202 and the second electrode 203 each are formed in the form of a single layer, at least one of the first electrode 202 or the second electrode 203 may be formed in the form of a plurality of layers.

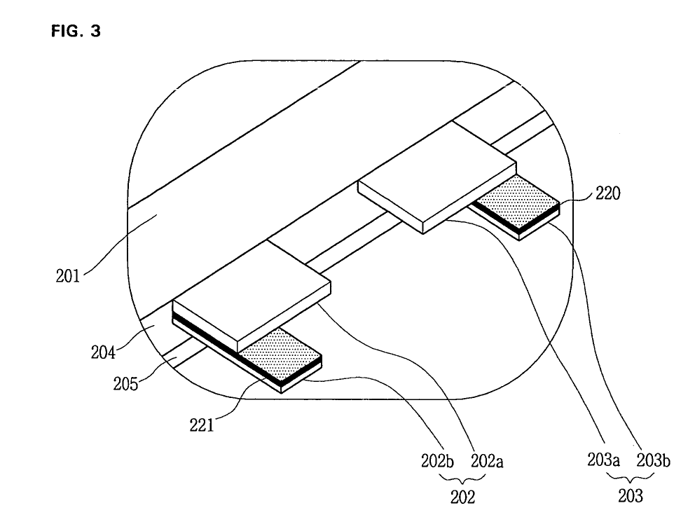

FIG. 3 illustrates the structure of an electrode of the plasma display panel according to one embodiment.

Referring to FIG. 3, the first electrode 202 and the second electrode 203 each are formed in the form of a plurality of layers.

The first electrode 202 and the second electrode 203 each include bus electrodes 202b and 203b and transparent electrodes 202a and 203a to emit light generated inside the discharge cells to the outside and secure the driving efficiency. The bus electrodes 202b and 203b include a material with high electrical conductivity such as silver (Ag), and the transparent electrodes 202a and 203a include a transparent material such as indium-tin-oxide (ITO).

When the first electrode 202 and the second electrode 203 each include the bus electrodes 202b and 203b and the transparent electrodes 202a and 203a, black layers 220 and 221 are further formed between the bus electrodes 202b and 203b and the transparent electrodes 202a and 203a to prevent the reflection of external light caused by the bus electrodes 202b and 203b.

Although it is not illustrated in the attached drawings, the first electrode 202 and the second electrode 203 each may include only the bus electrodes 202b and 203b.

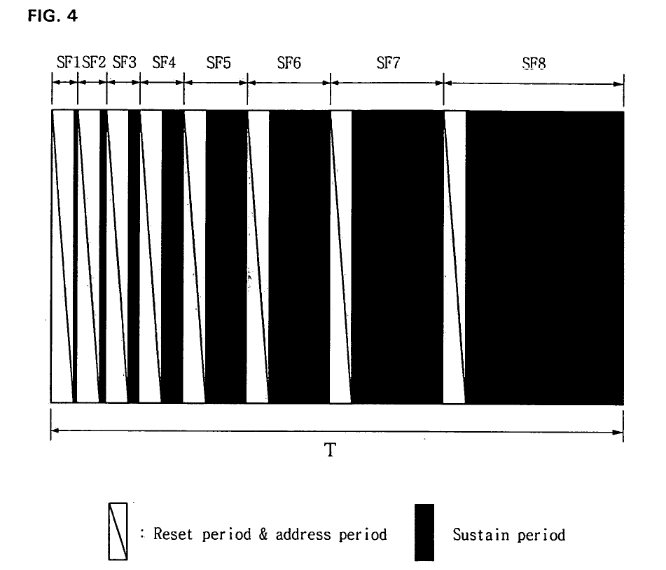

FIG. 4 illustrates a method for representing a gray level of an image in the plasma display apparatus according to one embodiment.

Referring to FIG. 4, in the plasma display apparatus according to one embodiment, a frame is divided into several subfields having a different number of emission times.

Each subfield is subdivided into a reset period for initializing all the discharge cells, an address period for selecting cells to be discharged, and a sustain period for representing gray level in accordance with the number of discharges.

The number of subfields constituting one frame may vary with a gray level to be represented.

For example, if an image with 256-level gray level is to be displayed, a frame, as illustrated in FIG. 4, is divided into 8 subfields SF1 to SF8. The number of sustain signals supplied during a sustain period of each subfield determines gray level weight in each subfield.

For example, in such a method of setting gray level weight of a first subfield to 2⁰ and setting gray level weight of a second subfield to 2¹, the sustain period increases in a ratio of 2ⁿ (where, n=0, 1, 2, 3, 4, 5, 6, 7) in each of the subfields. Since the sustain period varies from one subfield to the next subfield, a specific gray level is achieved by controlling the sustain period which are to be used for discharging each of the selected cells, i.e., the number of sustain discharges that are realized in each of the discharge cells.

The plasma display panel according to one embodiment uses a plurality of frames to display an image during 1 second. For example, 60 frames are used to display an image during 1 second. In this case, a duration (T) of time of one frame may be 1/60 seconds, i.e., 16.67 ms.

Although FIG. 4 has illustrated and described the subfields arranged in increasing order of gray level weight, the subfields may be arranged in decreasing order of gray level weight, or the subfields may be arranged regardless of gray level weight.

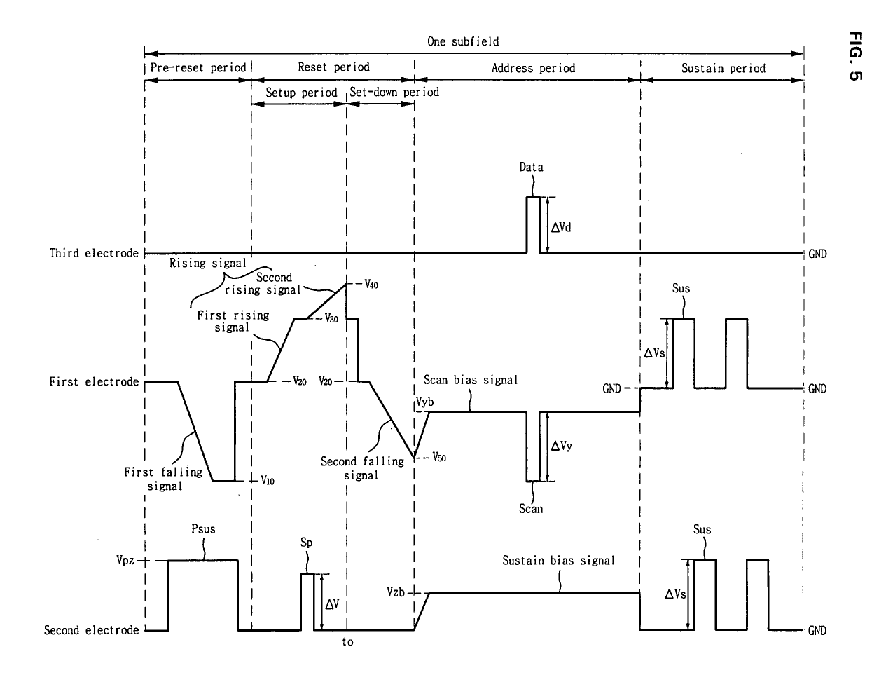

FIG. 5 illustrates a driving waveform supplied during one subfield when driving the plasma display apparatus according to one embodiment.

Referring to FIG. 5, during a pre-reset period prior to a reset period, a first falling signal is supplied to a first electrode Y. During the supplying of the first falling signal to the first electrode Y, a pre-sustain signal (Psus) of a polarity opposite a polarity of the first falling signal is supplied to a second electrode Z.

The first falling signal supplied to the first electrode Y gradually falls to a first voltage V10.

A voltage Vpz of the pre-sustain signal (Psus) is substantially equal to a voltage Vs of a sustain signal (Sus) which will be supplied during a sustain period.

As above, the first falling signal is supplied to the first electrode Y and the pre-sustain signal is supplied to the second electrode Z during the pre-reset period such that wall charges of a predetermined polarity are accumulated on the first electrode Y and wall charges of a polarity opposite the polarity of the wall charges accumulated on the first electrode Y are accumulated on the second electrode Z. For example, wall charges of a positive polarity are accumulated on the first electrode Y, and wall charges of a negative polarity are accumulated on the second electrode Z.

As a result, the initialization of all the discharge cells formed in the plasma display panel is stably performed during the reset period which follows the pre-reset period.

Further, even if a rising signal having a relatively low voltage is supplied to the first electrode Y during the reset period, the initialization of all the discharge cells is stably performed.

A first subfield in a plurality of subfields of one frame may include a pre-reset period prior to a reset period. The first and second subfields or the first, second and third subfields in the plurality of subfields may include a pre-reset period prior to a reset period.

Each subfield may not include the pre-reset period.

During the reset period which follows the pre-reset period, a rising signal and a second falling signal are supplied to the first electrode Y and a positive polarity signal (Sp) is supplied to the second electrode Z.

The rising signal includes a first rising signal and a second rising signal. The first rising signal gradually rises from a second voltage V20 to a third voltage V30 with a first slope, and the second rising signal gradually rises from the third voltage V30 to a fourth voltage V40 with a second slope.

The second slope of the second rising signal is gentler than the first slope of the first rising signal. When the second slope is gentler than the first slope, the quantity of light generated by a setup discharge is reduced such that contrast of the plasma display apparatus is improved.

The positive polarity signal (Sp) is supplied to the second electrode Z during the supplying of the rising signal or before an end time point of the rising signal.

It is preferable that the width of the positive polarity signal (Sp) is smaller than the width of a sustain signal having the widest width in the plurality of sustain signals supplied to at least one of the first electrode or the second-electrode-during the sustain period.

A magnitude (ΔV) of a voltage of the positive polarity signal (Sp) is substantially equal to a magnitude (ΔVs) of the voltage of the sustain signal (Sus) supplied to at least one of the first electrode or the second electrode during the sustain period. During a setup period of the reset period, the rising signal generates a weak setup discharge inside the discharge cells, thereby accumulating a predetermined amount of wall charges inside the discharge cells.

The positive polarity signal (Sp) reduces the amount of wall charges excessively accumulated inside the discharge cells, thereby reducing the generation of an erroneous discharge during the address period and the sustain period

During a set-down period of the reset period, the second falling signal of a polarity opposite a polarity of the rising signal is supplied to the first electrode Y.

The second falling signal gradually falls from the second voltage V20 to a fifth voltage V50. The second falling signal generates a weak erase discharge (i.e., a set-down discharge) inside the discharge cells. Furthermore, the remaining wall charges are uniform inside the discharge cells to the extent that an address discharge can be stably performed.

During the address period, a scan bias signal, which gradually rises from the fifth voltage V50 to a voltage Vyb and then is maintained at the voltage Vyb, is supplied to the first electrode Y. A scan signal (Scan), which falls from the voltage Vyb of the scan bias signal by a scan voltage magnitude ΔVy, is supplied to all the first electrodes Y1 to Yn.

In this case, the width of the scan signal (Scan) may vary from one subfield to the next subfield. For example, the width of a scan signal in the next subfield.

When the scan signal (Scan) is supplied to the first electrode Y, a data signal (Data) corresponding to the scan signal (Scan) is supplied to the third electrode X. The data signal (Data) rises from a ground level voltage GND by a data voltage magnitude ΔVd.

As the voltage difference between the scan signal (Scan) and the data signal (Data) is added to the wall voltage generated during the reset period, the address discharge occurs within the discharge cells to which the data signal (Data) is supplied.

A sustain bias signal is supplied to the second electrode Z during the address period to prevent the generation of the unstable address discharge.

The sustain bias signal is supplied to the second electrode Z after the passage of a predetermined duration of time from the supplying of the positive polarity signal (Sp). In this case, a duration of time ranging from an end time point of the supplying of the positive polarity signal (Sp) to a start time point of the supplying of the sustain bias signal is longer than the width of the positive polarity signal (Sp).

When the width of the positive polarity signal (Sp) is set to a, and the duration of time ranging from the end time point of the supplying of the positive polarity signal (Sp) to the start time point of the supplying of the sustain bias signal is set to b, a ratio (b/a) of “b” to “a” is more than 1 and is equal to or less than 10. In this case, stable discharges occur during the reset period and the address period.

A supply time point of the sustain bias signal may correspond to a supply time point of the scan bias signal. Although it is not illustrated in the attached drawings, the sustain bias signal may be supplied to the second electrode Z during the set-down period or near the beginning of the address period.

A voltage Vzb of the sustain bias signal is lower than the voltage of the sustain signal which will be supplied during the sustain period, and is higher than the ground level voltage GND. Further, the voltage Vzb of the sustain bias signal is lower than the positive polarity signal (Sp).

During the sustain period, a sustain signal (Sus) is alternately supplied to the first electrode Y and the second electrode Z.

As the wall voltage within the discharge cell selected by performing the address discharge is added to a sustain voltage Vs of the sustain signal (Sus), every time the sustain signal (Sus) is supplied, a sustain discharge, i.e., a display discharge occurs between the first electrode Y and the second electrode Z.

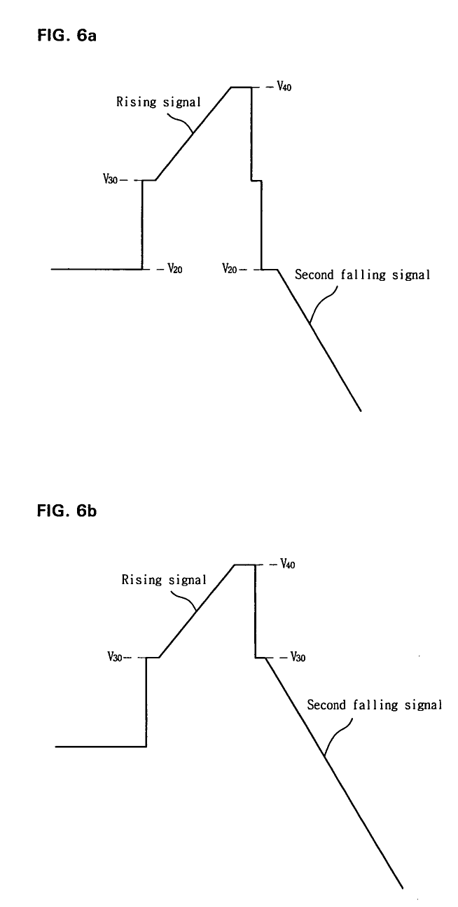

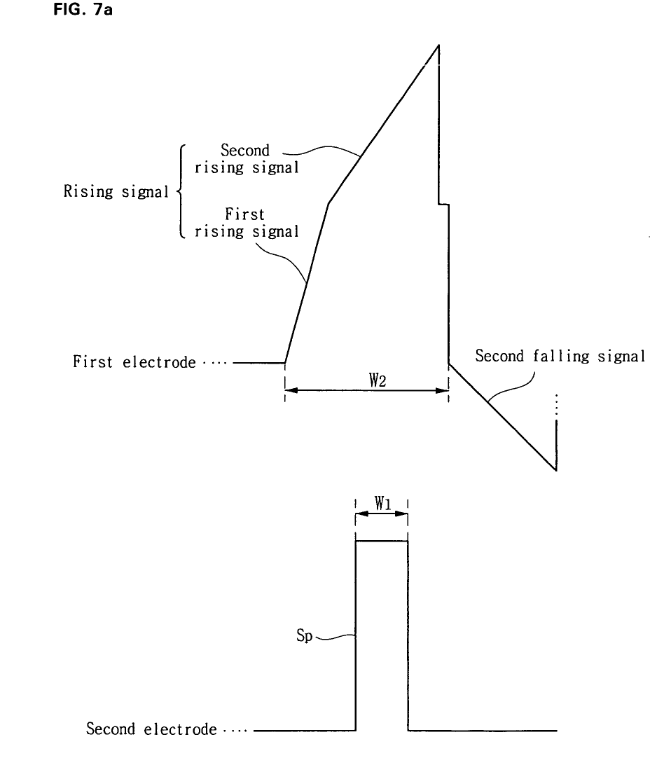

FIGS. 6a and 6b illustrate modifications of a rising signal and a second falling signal of FIG. 5.

Referring to FIG. 6a, the rising signal sharply rises to the third voltage V30, and then gradually rises from the third voltage V30 to the fourth voltage V40.

As above, the slope of the rising signal may vary.

Referring to FIG. 6b, the second falling signal gradually falls from the third voltage V30.

As above, a voltage falling time point of the second falling signal is changeable.

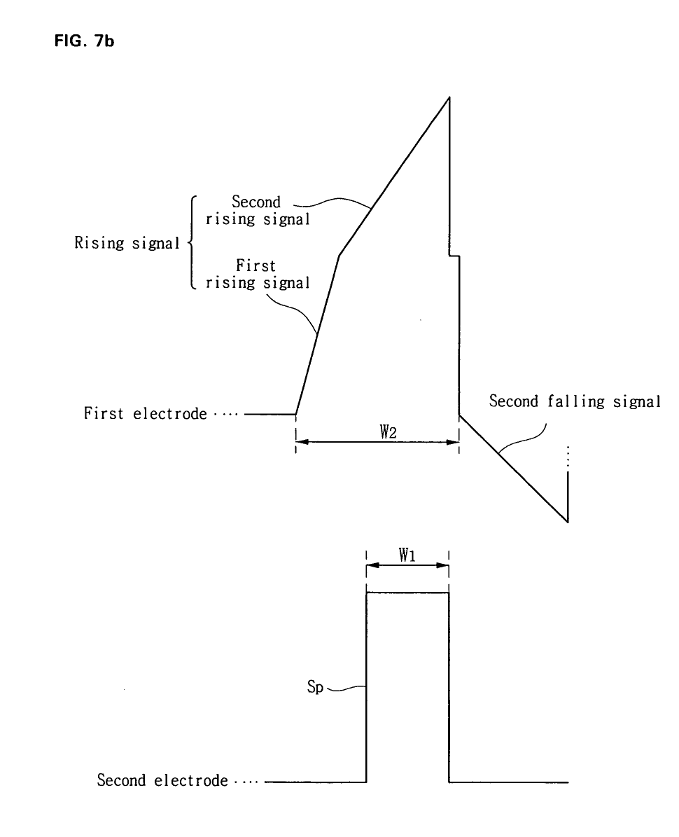

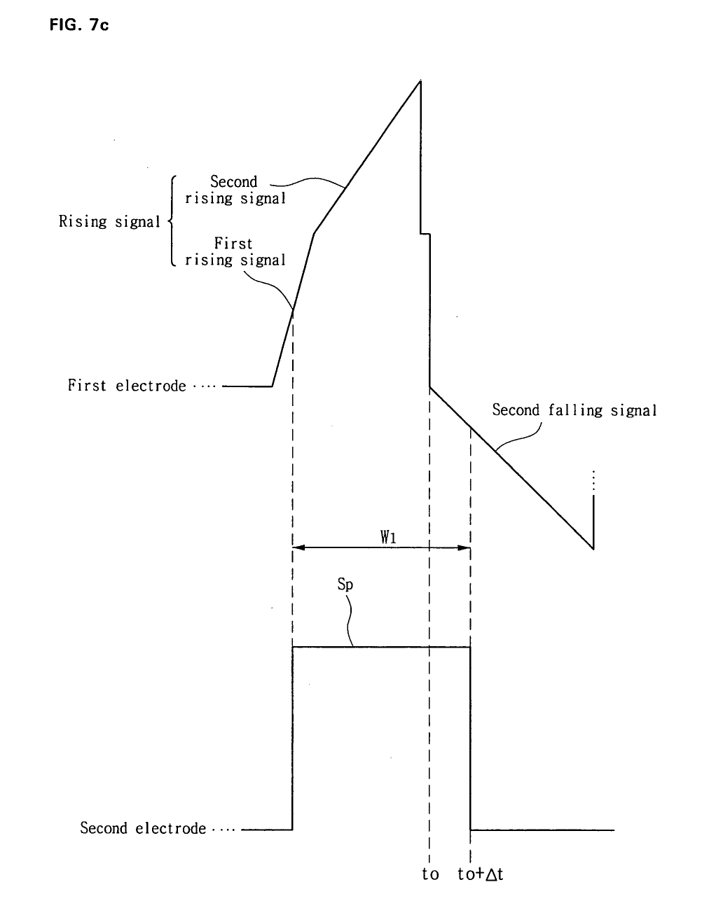

FIGS. 7a to 7c illustrate modifications of a supply time point of a positive polarity signal of FIG. 5.

Referring to FIG. 7a, the positive polarity signal (Sp) is supplied to the second electrode Z during the supplying of the rising signal to the first electrode Y. Preferably, the positive polarity signal (Sp) is supplied to the second electrode Z during the supplying of the second rising signal to the first electrode Y.

Thus, a width W1 of the positive polarity signal (Sp) is less than a width W2 of the rising signal.

In this case, the positive polarity signal (Sp) is supplied to the second electrode before an end time point of the supplying of the second rising signal.

Referring to FIG. 7b, the positive polarity signal (Sp) is supplied to the second electrode Z during the supplying of the rising signal to the first electrode Y. As compared with FIG. 7a, an end time point of the supplying of the positive polarity signal (Sp) corresponds to an end time point of the supplying of the second rising signal.

Referring to FIG. 7c, the positive polarity signal (Sp) is supplied to the second electrode Z during the supplying of the rising signal and the second falling signal to the first electrode Y.

For example, assuming than an end time point of the supplying of the rising signal is t0, the supplying of the positive polarity signal (Sp) starts prior to the time point t0 and then ends at a time point t0+Δt.

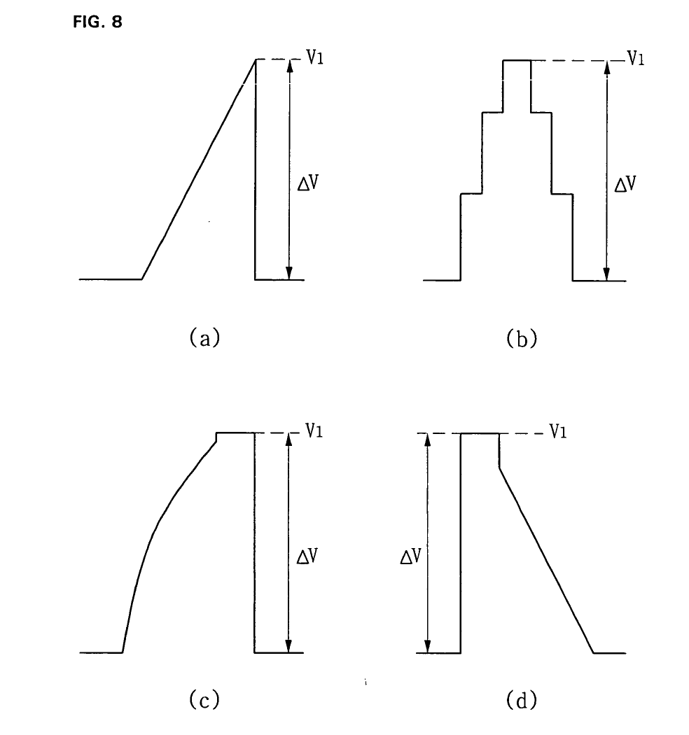

FIG. 8 illustrates modifications of a shape pattern of a positive polarity signal of FIG. 5.

The positive polarity signal (Sp), as illustrated in FIG. 5, may have a square wave form. As illustrated in (a) and (b) of FIG. 8, the positive polarity signal may have a triangle wave form or a step form.

As illustrated in (c) of FIG. 8, the positive polarity signal may have a curve form. In other words, the positive polarity signal rises to a voltage V1 and then falls from the voltage V1 by a voltage magnitude ΔV.

As illustrated in (d) of FIG. 8, the positive polarity signal may have a form of sharply rising to a voltage V1 and then gradually falling from a predetermined voltage lower than the voltage V1.

The positive polarity signal may be supplied to the second electrode Z during a reset period of each of a plurality of subfields constituting a frame.

Further, the positive polarity signal may be supplied to the second electrode Z during a reset period of a specific subfield in a plurality of subfields constituting a frame.

For example, when one frame includes a total of 8 subfields, i.e., first to eighth subfields, the positive polarity signal may be supplied to the second electrode Z during a reset period of the first subfield of the 8 subfields, and the positive polarity signal may be omitted in the remaining second to eighth subfields.

Further, the positive polarity signal may not be supplied to the second electrode Z in the first subfield of the 8 subfields, and the positive polarity signal may be supplied to the second electrode Z in the remaining second to eighth subfields.

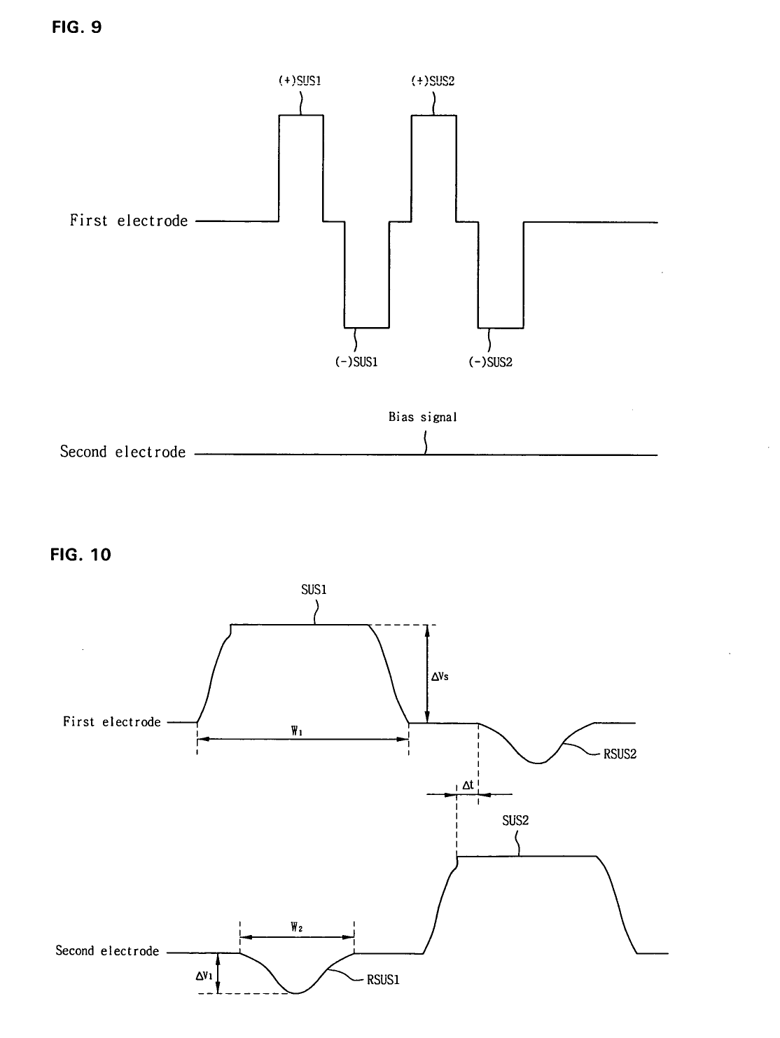

FIG. 9 illustrate a modification of a sustain signal of FIG. 5.

Referring to FIG. 9, when sustain signals (+SUS1 and +SUS2) of a positive polarity and sustain signals (−SUS1 and −SUS2) of a negative polarity are alternately supplied to the first electrode Y, a bias signal is supplied to the second electrode Z. On the contrary, during the supplying of a bias signal to the first electrode Y, a sustain signal of a positive polarity and a sustain signal of a negative polarity may be alternately supplied to the second electrode Z.

The bias signal is maintained at the ground level voltage GND.

As above, when the sustain signal is supplied to either the first electrode Y or the second electrode Z, a single diving board for driving the first electrode Y and the second electrode Z during the sustain period may be installed.

Accordingly, the whole size of a driver for driving the plasma display panel is reduced such that the manufacturing cost is reduced.

FIG. 10 illustrate another modification of a sustain signal of FIG. 5.

Referring to FIG. 10, during the supplying of a sustain signal to the first electrode Y in the sustain period, an auxiliary signal of a polarity opposite a polarity of the sustain signal is supplied to the second electrode Z. On the contrary, during the supplying of a sustain signal to the second electrode Z, an auxiliary signal of a polarity opposite a polarity of the sustain signal is supplied to the first electrode Y.

Hereinafter, a sustain signal supplied to the first electrode Y is referred to as a first sustain signal, and a sustain signal supplied to the second electrode Z is referred to as a second sustain signal. Further, an auxiliary signal supplied to the first electrode Y is referred to as a first reverse sustain signal, and an auxiliary signal supplied to the second electrode Z is referred to as a second reverse sustain signal.

More specifically, during the sustain period, a first sustain signal SUS1 is supplied to the first electrode Y and a second sustain signal SUS2 is supplied to the second electrode Z. During a portion of a supply period of the first sustain signal SUS1 to the first electrode Y, a first reverse sustain signal RSUS1 is supplied to the second electrode Z. During a portion of a supply period of the second sustain signal SUS2 to the second electrode Z, a second reverse sustain signal RSUS2 is supplied to the first electrode Y.

In this case, slopes of the reverse sustain signals RSUS1 and RSUS2 are gentler than slopes of the sustain signals SUS1 and SUS2.

Further, widths W2 of the reverse sustain signals RSUS1 and RSUS2 are less than widths W1 of the sustain signals SUS1 and SUS2.

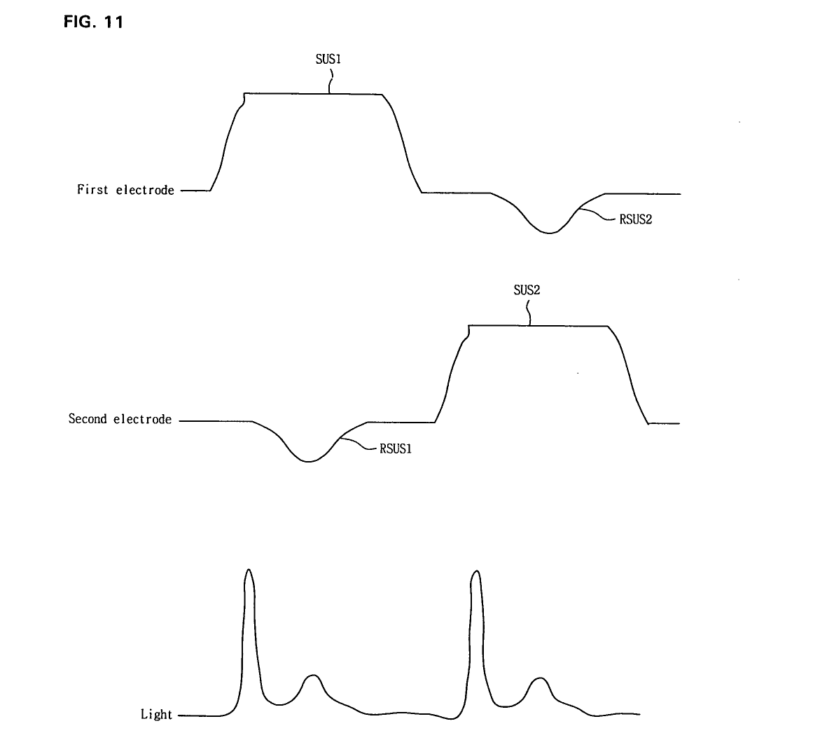

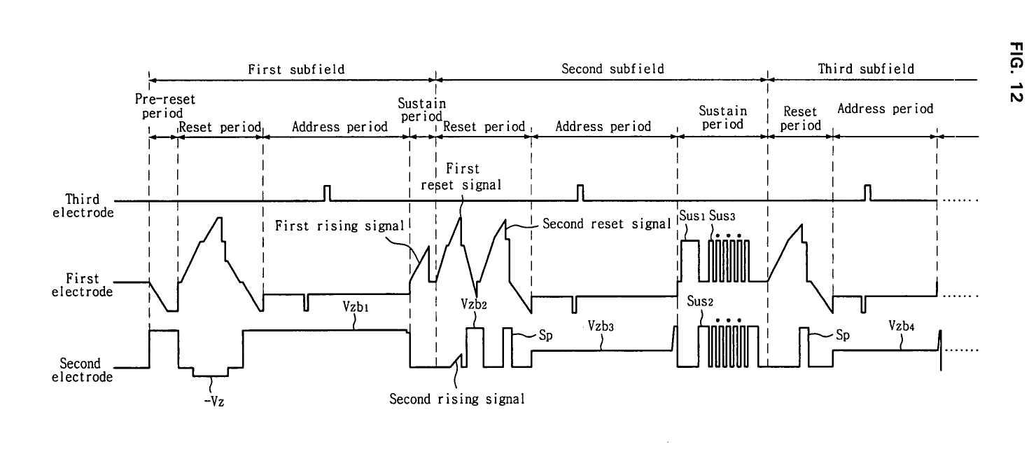

FIG. 11 illustrates a light characteristic depending on a sustain signal of FIG. 10.

Referring to FIG. 11, light generated by the sustain signal of FIG. 10 is generated around a supply time point of the first and second sustain signals SUS1 and SUS2, and is maintained during the supplying of the first and second reverse sustain signals RSUS1 and RSUS2.

Therefore, the quantity of light generated during the sustain period increases such that luminance is improved.

In this case, to more efficiently maintain the generation of the light generated by the first and second sustain signals SUS1 and SUS2 using the first and second reverse sustain signals RSUS1 and RSUS2, slopes of the first and second reverse sustain signals RSUS1 and RSUS2 are controlled. In other words, falling slopes of the first and second reverse sustain signals RSUS1 and RSUS2 are gentler than rising slopes of the first and second sustain signals SUS1 and SUS2.

Accordingly, a discharge excessively generated during sustain period is prevented such that an excessive reduction in the wall charges is prevented.

FIG. 12 illustrates another example of an operation of the plasma display apparatus according to one embodiment.

The description of the operation of the plasma display apparatus which has previously illustrated and described in FIG. 4 is omitted in FIG. 12. Referring to FIG. 12, a sustain signal may not be supplied during a sustain period of at least one subfield of a plurality of subfields.

For example, as illustrated in FIG. 12, a sustain signal is not supplied during a sustain period of a first subfield of the plurality of subfields. When the sustain signal is not supplied during the sustain period of the first subfield, a reset discharge and an address discharge occur during a reset period and an address period of the first subfield. Therefore, a gray level of an image is represented in the first subfield using reset light generated by the reset discharge and address light generated by the address discharge.

Since the gray level of the image is represented using light of intensity less than intensity of light generated in a subfield when the sustain signal is supplied, representability of gray level is improved.

Further, a positive polarity signal (Sp) may not be supplied to the second electrode Z during a reset period of a subfield, when a sustain signal is not supplied during a sustain period or the sustain period is omitted.

Although FIG. 12 has illustrated a case where the sustain signal is not supplied during the sustain period of the first subfield, the sustain period may be omitted in the first subfield.

The effect of a case where the sustain period is omitted is substantially the same as the effect of a case where the sustain signal is not supplied.

A first rising signal instead of a sustain signal may be supplied to the first electrode during a sustain period of a subfield when the sustain signal is not supplied during the sustain period.

A reason to supply the first rising signal is as follows.

After supplying a data signal to the third electrode during an address period of a subfield, when a sustain signal is not supplied during a sustain period or the sustain period is omitted, a self-erase discharge may occur between the first electrode and the second electrode due to a voltage difference between the first electrode and the second electrode prior to a reset period of the next subfield. The self-erase discharge may make the amount of wall charges inside the discharge cells insufficient.

On the other hand, if a first rising signal instead of a sustain signal is supplied to the first electrode during a sustain period of a subfield when the sustain signal is not supplied during the sustain period, a sharp change in a voltage difference between the first electrode and the second electrode is prevented between an address period of the subfield and a reset period of the next subfield. Therefore, a self-erase discharge between the first electrode and the second electrode is prevented.

Further, a plurality of reset signals may be supplied during a reset period of the next subfield of a subfield, when a sustain signal is not supplied during a sustain period or the sustain period is omitted.

For example, a first reset signal and a second reset signal are supplied to the first electrode during a reset period of a second subfield subsequent to the first subfield, when the sustain signal is not supplied during the sustain period.

A reason to supply the plurality of reset signals during the reset period of the next subfield of the subfield, when the sustain signal is not supplied during the sustain period or the sustain period is omitted, is as follows.

Since a sustain discharge does not occur in a subfield, when a sustain signal is not supplied during a sustain period or the sustain period is omitted, a state of wall charges distributed inside the discharge cells in the subfield is more unstable than a state of wall charges distributed inside discharge cells in a subfield when a sustain signal is supplied. Accordingly, a state of wall charges distributed inside the discharge cells is uniform by supplying a plurality of reset signals during a reset period of the next subfield of the subfield, when the sustain signal is not supplied during the sustain period or the sustain period is omitted.

In this case, as illustrated in FIG. 12, a second sustain bias signal (Vzb2) is supplied to the second electrode between the supplying of the first reset signal and the supplying of the second reset signal in the second subfield.

The second sustain bias signal (Vzb2) prevents an erroneous discharge between the first electrode and the second electrode.

During the supplying of the first reset signal to the first electrode, a second rising signal is supplied to the second electrode to suppress the generation of an over-discharge between the first electrode and the second electrode.

Further, a positive polarity signal (Sp) is supplied during the reset period of the second subfield when the plurality of reset signals are supplied.

One or more sustain signals are supplied to at least one of the first electrode or the second electrode during a sustain period of the second subfield. In this case, the width of a first sustain signal (SUS1), that is first supplied during the sustain period of the second subfield, is more than the widths of the other sustain signals.

Assuming that the width of the first sustain signal (SUS1), that is first supplied during the sustain period of the second subfield, is the widest of the widths of all the sustain signals supplied during the sustain period of the second subfield, the width of the first sustain signal (SUS1) may be more than the width of the positive polarity signal (Sp) supplied the second electrode during the reset period of the second subfield.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display apparatus, comprising:
a plasma display panel including a first electrode and a second electrode; and
a driver that supplies a rising signal and a falling signal to the first electrode during a reset period, supplies a positive polarity signal to the second electrode during the reset period, and supplies a sustain bias signal to the second electrode after the passage of a predetermined duration of time from an end time point of the supplying of the positive polarity signal.

2. The plasma display apparatus of claim 1, wherein the sustain bias signal is supplied to the second electrode during a set-down period of the reset period or near the beginning of an address period.

3. The plasma display apparatus of claim 1, wherein the positive polarity signal is supplied to the second electrode during the supplying of the rising signal to the first electrode.

4. The plasma display apparatus of claim 1, wherein the positive polarity signal is supplied to the second electrode prior to an end time point of the supplying of the rising signal.

5. The plasma display apparatus of claim 1, wherein a magnitude of a voltage of the positive polarity signal is substantially equal to a magnitude of a voltage of a sustain signal supplied to the first electrode or the second electrode during a sustain period.

6. The plasma display apparatus of claim 1, wherein a magnitude of a voltage of the positive polarity signal is more than a magnitude of a voltage of the sustain bias signal.

7. The plasma display apparatus of claim 1, wherein the width of the positive polarity signal is smaller than the width of a sustain signal having the widest width in a plurality of sustain signals supplied to the first electrode or the second electrode during a sustain period.

8. The plasma display apparatus of claim 1, wherein the driver supplies the positive polarity signal to the second electrode during reset periods of one or more subfields of the remaining subfields except a first subfield in a plurality of subfields of a frame.

9. The plasma display apparatus of claim 1, wherein the predetermined duration of time ranging from the end time point of the supplying of the positive polarity signal to a start time point of the supplying of the sustain bias signal is longer than the width of the positive polarity signal.

10. The plasma display apparatus of claim 9, wherein when the width of the positive polarity signal is set to a, and the predetermined duration of time ranging from the end time point of the supplying of the positive polarity signal to the start time point of the supplying of the sustain bias signal is set to b, a ratio (b/a) of “b” to “a” is more than 1 and is equal to or less than 10.

11. A method of driving a plasma display apparatus, comprising;
supplying a rising signal and a falling signal to a first electrode during a reset period;
supplying a positive polarity signal to a second electrode during the reset period; and
supplying a sustain bias signal to the second electrode after the passage of a predetermined duration of time from an end time point of the supplying of the positive polarity signal to the second electrode.

12. The method of claim 11, wherein the sustain bias signal is supplied to the second electrode during a set-down period of the reset period or near the beginning of an address period.

13. The method of claim 11, wherein the positive polarity signal is supplied to the second electrode during the supplying of the rising signal to the first electrode.

14. The method of claim 11, wherein the positive polarity signal is supplied to the second electrode prior to an end time point of the supplying of the rising signal.

15. The method of claim 11, wherein a magnitude of a voltage of the positive polarity signal is substantially equal to a magnitude of a voltage of a sustain signal supplied to the first electrode or the second electrode during a sustain period.

16. The method of claim 11, wherein a magnitude of a voltage of the positive polarity signal is more than a magnitude of a voltage of the sustain bias signal.

17. The method of claim 11, wherein the width of the positive polarity signal is smaller than the width of a sustain signal having the widest width in a plurality of sustain signals supplied to the first electrode or the second electrode during a sustain period.

18. The method of claim 11, wherein the positive polarity signal is supplied to the second electrode during reset periods of one or more subfields of the remaining subfields except a first subfield in a plurality of subfields of a frame.

19. The method of claim 11, wherein the predetermined duration of time ranging from the end time point of the supplying of the positive polarity signal to a start time point of the supplying of the sustain bias signal is longer than the width of the positive polarity signal.

20. The method of claim 19, wherein when the width of the positive polarity signal is set to a, and the predetermined duration of time ranging from the end time point of the supplying of the positive polarity signal to the start time point of the supplying of the sustain bias signal is set to b, a ratio (b/a) of “b” to “a” is more than 1 and is equal to or less than 10.
